(19) United States
(12) Patent Application Publication
(10) Pub. No.: US 2019/0286874 A1
(43) Pub. Date: Sep. 19, 2019

(54) METHOD AND ELECTRONIC DEVICE FOR GENERATING FINGERPRINT INFORMATION, BASED ON MULTIPLE PIECES OF IMAGE INFORMATION ACQUIRED USING MULTIPLE DRIVING SCHEMES

(71) Applicant: Samsung Electronics Co., Ltd., Gyeonggi-do (KR)

(72) Inventors: Minwoo LEE, Gyeonggi-do (KR); Seoyoung LEE, Gyeonggi-do (KR); Juseok LEE, Gyeonggi-do (KR); Wonhee CHOE, Gyeonggi-do (KR)

(21) Appl. No.: 16/351,710

(22) Filed: Mar. 13, 2019

(30) Foreign Application Priority Data
Mar. 13, 2018 (KR) 10-2018-0029361

(51) Int. Cl. G06K 9/00; G06T 5/50

(52) U.S. Cl. CPC G06K 9/00033; G06T 2207/20224; G06K 9/00026; G06T 5/50

(57) ABSTRACT

Certain embodiments relate to an apparatus and method for recognizing a fingerprint on the basis of a driving scheme to improve sensitivity of a fingerprint sensor in an electronic device. In one embodiment, the electronic device may include a touch panel comprising a plurality of electrodes and a plurality of channel electrically coupled in a designated direction with the plurality of electrodes in at least part of designated regions, a touch control circuit for driving the touch panel, and a processor, wherein the processor is configured to identify an input of an external object in the designated regions; acquire a first image for the external object in a state where two or more channels out of the plurality of channels are coupled by the touch control circuit, based at least on the input; acquire a second image for the external object in a state where another two or more channels out of the plurality of channels are coupled by the touch control circuit, based at least on the input; and authenticating the external object with the first image and the second image, thereby generating fingerprint information.

### CROSS REFERENCE TO RELATED APPLICATION(S)

This application is based on and claims priority under 35 U.S.C. § 119 to Korean Patent Application No. 10-2018-0029361, filed on Mar. 13, 2018, in the Korean Intellectual Property Office, the disclosure of which is incorporated by reference herein in its entirety.

### BACKGROUND

### Field

Certain embodiments relate to an electronic device and method for generating fingerprint information on the basis of a plurality of pieces of image information acquired by using a plurality of driving schemes to improve sensitivity of a fingerprint sensor in the electronic device.

### Description of Related Art

With the advance of information communication techniques and semiconductor techniques, an electronic device may provide various functions such as a broadcasting function, an audio output function, a wireless Internet function, a camera function, a user authentication function, and an electronic payment function. Due to an increase in personal information stored in the electronic device, it is important to secure access to the electronic device using authentication.

### SUMMARY

For example, an electronic device may provide an authentication service (e.g., a biometrics service) using biometric information such as an iris, a fingerprint, a face, a palm, a vein, or the like.

According to certain embodiments, an electronic device may include a touch panel comprising a plurality of electrodes and a plurality of channel electrically coupled in a designated direction with the plurality of electrodes in at least part of designated regions, a touch control circuit for driving the touch panel, and a processor, wherein the processor is configured to identify an input of an external object in the designated regions; acquire a first image for the external object in a state where two or more channels out of the plurality of channels are coupled by the touch control circuit, based at least on the input; acquire a second image for the external object in a state where another two or more channels out of the plurality of channels are coupled by the touch control circuit, based at least on the input; and authenticating the external object with the first image and the second image, thereby generating fingerprint information.

According to certain embodiments, there is a method executed in an electronic device with a touch panel comprising a plurality of electrodes and a plurality of channel electrically coupled in a designated direction with the plurality of electrodes in at least part of designated regions and a touch control circuit for driving the touch panel, the method comprising: identifying an input of an external object in the designated regions; acquiring a first image for the external object with two or more channels out of the plurality of channels, based at least on the input; acquiring a second image for the external object with another two or more channels out of the plurality of channels, based at least on the input; and authenticating the external object with the first image and the second image, thereby generating fingerprint information.

An electronic device and operating method thereof according to certain embodiments can improve sensitivity of a fingerprint sensor by using at least two or more channels out of a plurality of channels coupled with a plurality of electrodes included in the fingerprint sensor.

### BRIEF DESCRIPTION OF THE DRAWINGS

FIG. 1 is a block diagram illustrating an electronic device in a network environment according to certain embodiments;

FIG. 2 is a cross-sectional view illustrating that a user's finger is touched on a touch surface in a fingerprint sensor disposed to a display device;

FIG. 3 is a plan view illustrating a plurality of electrodes included in a fingerprint sensor;

FIG. 4 is a flowchart for recognizing a fingerprint on the basis of a driving method for improving sensitivity of a fingerprint sensor in an electronic device according to certain embodiments;

FIG. 5 illustrates an example in which a plurality of electrodes are coupled with a plurality of channels to improve sensitivity of a fingerprint sensor in an electronic device according to certain embodiments;

FIG. 6 illustrates an example in which a plurality of electrodes are coupled on an area basis to improve sensitivity of a fingerprint sensor in an electronic device according to certain embodiments;

FIG. 7 is a flowchart for acquiring an image by using channels overlapping with a region in which an external object is detected in an electronic device according to certain embodiments;

FIG. 8 illustrates an example for acquiring an image by using channels overlapping with a region in which an external object is detected in an electronic device according to certain embodiments;

FIG. 9 is a flowchart for acquiring a first image and a second image on the basis of different driving voltage in an electronic device according to certain embodiments;

FIG. 10 illustrates an example for acquiring a first image and a second image on the basis of different driving voltage in an electronic device according to certain embodiments;

FIG. 11 is a flowchart for generating fingerprint information on the basis of an adjacent channel influence level in an electronic device according to certain embodiments; and

FIG. 12 is a flowchart for additionally acquiring a third image to generate fingerprint information in an electronic device according to certain embodiments.

### DETAILED DESCRIPTION

Certain embodiments will be described hereinafter with reference to the accompanying drawings. Also, the terms used herein are defined by considering a function of an electronic device exemplified through certain embodiments. The terms used herein must be understood based on the descriptions made herein.

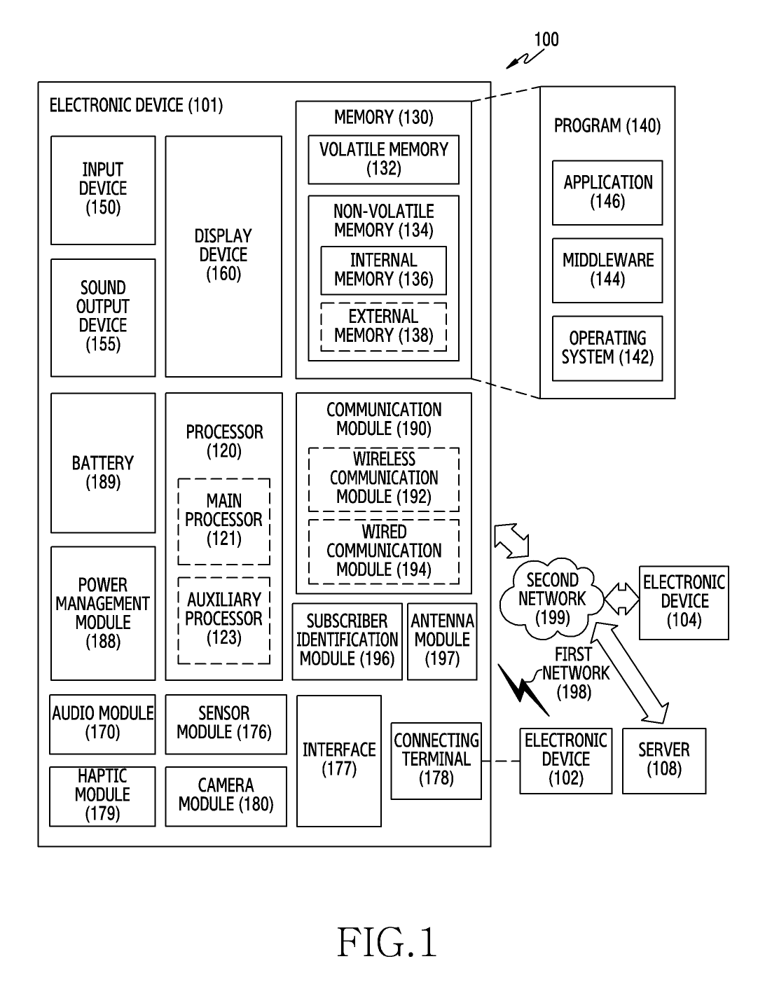

FIG. 1 is a block diagram illustrating an electronic device 101 in a network environment 100 according to certain embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa.

According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

Additionally, where “two or more” and “another two or more” is used, the another two or more refers to a set of items having at least one item that is different from the two or more, but may have other items that are common.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not subtract between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

According to certain embodiments, an electronic device may include a touch panel comprising a plurality of electrodes and a plurality of channel electrically coupled in a designated direction with the plurality of electrodes in at least part of designated regions; a touch control circuit for driving the touch panel; and a processor, wherein the processor is configured to: identify an input of an external object in the designated regions; acquire a first image for the external object in a state where two or more channels out of the plurality of channels are coupled by the touch control circuit, based at least on the input; acquire a second image for the external object in a state where another two or more channels out of the plurality of channels are coupled by the touch control circuit, based at least on the input; and authenticating the external object with the first image and the second image, thereby generating fingerprint information.

According to certain embodiments, the electronic device may further include a memory for storing exemplar fingerprint information, wherein the processor is configured to authenticate the fingerprint information using the exemplar fingerprint information.

According to certain embodiments, the electronic device may further include a display device, wherein the processor is configured to perform one or more operations associated with a designated security range when the external object is authenticated.

According to certain embodiments, the processor may be configured to acquire difference data corresponding to at least one channel common to the two or more channels and the another two or more channels by subtracting the second image from the first image; and generate the fingerprint information, based at least on the acquired difference data.

According to certain embodiments, the two or more channels, and the another two or more channels comprise at least one common channel.

According to certain embodiments, the processor may be configured to identify a region in which the external object is detected among the designated regions by using the touch control circuit; identify channels overlapping with the region in which the external object is detected by using the touch control circuit; acquire the first image for the external object in a state where the two or more channels are among the overlapping channels using the touch control circuit; and acquire the second image for the external object in a state where the another two or more channels are among the overlapping channels using the touch control circuit.

According to certain embodiments, the processor may be configured to acquire the first image by applying first driving voltage to the two or more channels using the touch control circuit; compare a first area of the two or more channels and a second area of the another two or more channels; and acquire the second image by applying second driving voltage to the another two or more channels using the touch control circuit if the first area and the second area are different by at least a designated rate.

According to certain embodiments, the processor may be configured to acquire the second image by applying the first driving voltage to the two or more channels coupled in the second designated manner by using the touch control circuit if the area (i.e., the first area) of the two or more channels coupled in the first designated manner and the area (the second area) of the two or more channels coupled in the second designated manner are identical by at least the designated ratio.

According to certain embodiments, the processor may be configured to identify an adjacent channel influence level associated with the plurality of channels, generate at least one corrected image out of the first image and the second image on the basis of the adjacent channel influence level, and generate the fingerprint information on the basis of the corrected image.

According to certain embodiments, the processor may be configured to identify difference data of the first image and the second image, determine whether it is possible to generate the fingerprint information on the basis of the difference data, acquire a third image for the external object in a state where two or more channels out of the plurality of channels are coupled in a third designated manner by using the touch control circuit on the basis of the input, if it is not possible to generate the fingerprint information, and generate the fingerprint information for authenticating the external object by using the first image, the second image, and the third image.

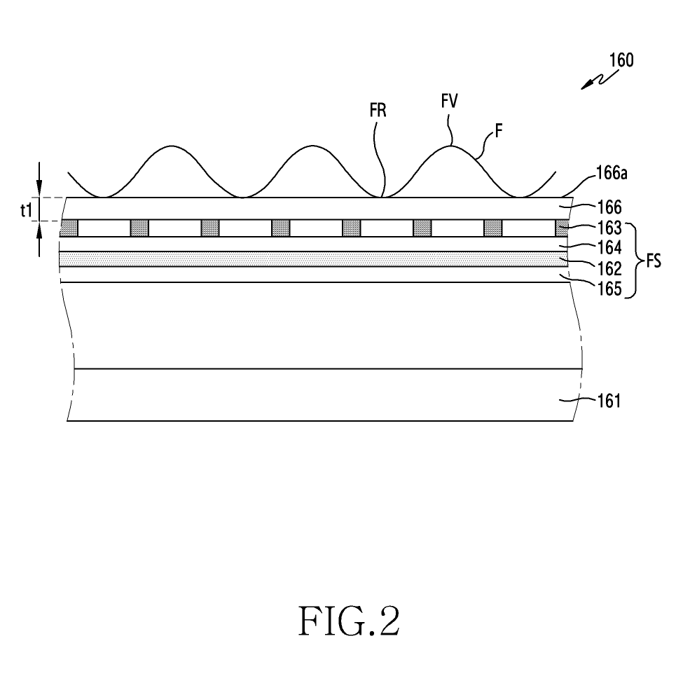

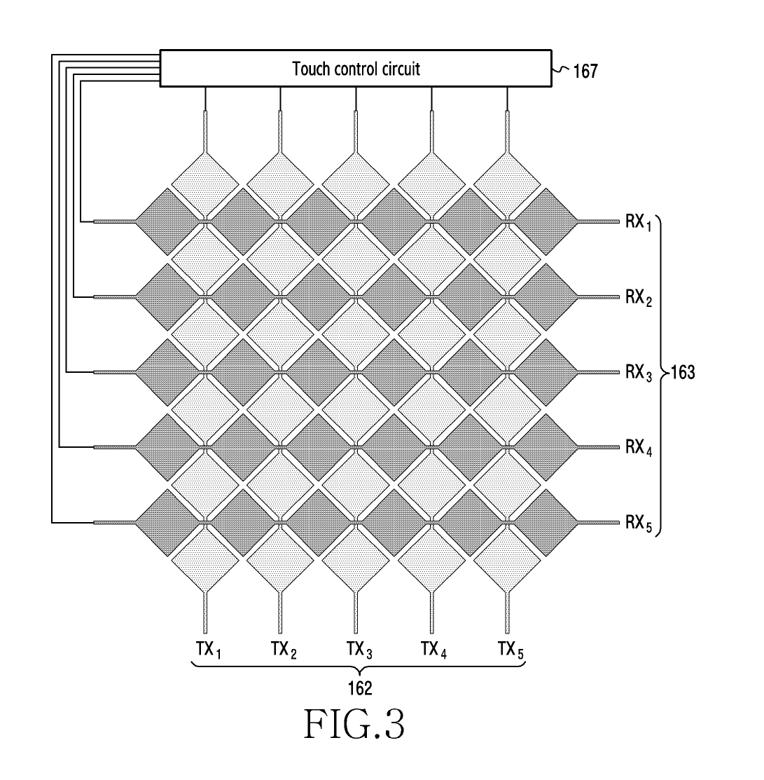

FIG. 2 is a cross-sectional view illustrating the response to a user's finger touching the touch surface in a fingerprint sensor disposed to a display device. FIG. 3 is a plan view illustrating a plurality of electrodes included in a fingerprint sensor. In the following description, the electronic device may include the electronic device 101 of FIG. 1 or at least part (e.g., the display device 160) of the electronic device 101.

Generally, electronic devices include high amounts of personal data. Unauthorized access of the personal data can be prevented by fingerprint authentication. Described below is way to detect a fingerprint of a user. The detected fingerprint can be used to compare to an exemplar fingerprint. If the detected fingerprint matches the exemplar fingerprint, access to the electronic device can be granted.

A fingertip has pattern of very fine Finger Ridges (FR) and Finger Valleys (FV) that form a fingerprint. A fingerprint can be detected by forming an image of the fingerprint on the fingertip touching the display. The image is formed by detecting capacitance (or inductance or resistance) changes between detection electrodes and driving electrodes.

The detection electrodes 163 and the driving electrodes 162 form a 2-D grid of crossing points about the display 161. When a fingertip touches the display, the pattern of the level of capacitance (inductance or resistance) changes and locations can be used to form an image of the fingerprint.

Referring to FIG. 2 and FIG. 3, the display device 160 of the electronic device 101 of FIG. 1 may include a display 161 (or a display module) for displaying an image, a Fingerprint Sensor (FS) disposed on at least part of the display 161, and a window cover 166 disposed on the FS and having a touch surface 166a to be touched by a user's finger. Although the FS is shown comprising certain layers in FIG. 2, the FS does not necessarily include each of the layers in other embodiments.

The display 161 (or the display module) may include, for example, and is not limited to, an organic light emitting display element or a liquid crystal display element.

In an embodiment, the FS may be disposed on the display 161. In another embodiment, the FS may be constructed integrally inside the display 161. When viewed from above, the FS may have a size overlapping with the entire region or at least part of the region on the display 161.

The FS may include a driving electrode portion 162 and a detection electrode 163. The driving electrode portion 162 may include a plurality of driving channels (e.g., TX1 to TX5) electrically coupled in a designated direction with a plurality of driving electrodes. The detection electrode portion 163 may include a plurality of detection channels (e.g., RX1 to RX5) coupled with a plurality of detection electrodes disposed in parallel (substantially parallel, or within 5 degrees of parallel) coupled with plurality of driving electrodes. The driving channels (TX1 to TX5) and the detection channels (RX1 to RX5) may have a crossing direction (e.g., an orthogonal direction, substantially orthogonal, or within 5 degrees of orthogonal) with respect to each other.

The driving channels (TX1 to TX5) transmit a signal. During transmission of the signal by the driving channels, the detection channels (RX1 to RX5) detect electrical changes (capacitance, inductance, resistance) as a result of the incident fingerprint.

Each of the plurality of driving channels (e.g., TX1 to TX5) and the plurality of detection channels (e.g., RX1 to RX 5) may have, for example, a shape in which a plurality of lozenge patterns are coupled. The plurality of driving channels (e.g., TX1 to TX5) and the plurality of detection channels (e.g., RX1 to RX5) may be constructed by including at least part of a transparent conductive material.

Although FIG. 3, shows five driving channels TX1 to TX5 and five detection channels RX1 to RX5, it shall be noted that virtually any number of driving channels and detection channels may be included. In one embodiment, the number of driving channels TX1 to TX5 and detection channels RX1 to RX5 may be based on the length and width of the display. For example, if the display is 3 inches by 5 inches and the width of an FR or FV is 0.5 mm, the number may be 3 or 5 inches/0.5 mm (approximately 150 to 250). In an embodiment, the FS may use a scheme in which the plurality of driving channels (e.g., TX1 to TX5) and the plurality of detection channels (e.g., RX1 to RX5) cross one another (e.g., a mutual scheme). In this scheme, the plurality of driving channels and the plurality of detection channels may be constructed in the same layer, and may be insulated through a bridge at crossing points. In another embodiment, the FS may use a scheme (e.g., a self-type) in which the plurality of driving channels and the plurality of detection channels are constructed of respective individual electrodes.

For example, an insulation layer 164 may be disposed between the driving electrode portion 162 and the detection electrode portion 163. The insulation layer 164 may be disposed between the driving electrode portion 162 and the detection electrode portion 163 so that they are insulated from each other. The driving electrode portion 162, the insulation layer 164, and the detection electrode portion 163 may be sequentially disposed on a support layer 165. The support layer 165 may be constructed of an insulation material having a transparent property, and may serve as a support to construct the driving electrode portion 162, the insulation layer 164, and the detection electrode portion 163. In an embodiment, the support layer 165 may function as a shield layer to prevent abnormal driving of the FS due to a noise which may be generated when the display device 160 is driven. In some embodiments, an additional shield layer (not shown) may be further disposed to an upper portion and/or lower portion of the support layer 165. That is, the support layer 165 (or the shield layer) may be driven as a ground (GND). In certain embodiments, the support layer 165 (or the shield layer) may always be in a ground state, or may be configured to be operatively coupled with at least one processor (e.g., a touch control circuit 167) so as to be grounded only when the FS is driven. For example, it may be driven to have the same waveform (e.g., the same frequency, the same phase, or the same electric potential) as a driving waveform of the FS.

As such, an FS additionally prepared in such a manner that the driving electrode portion 162, the insulation layer 164, and the detection electrode portion 163 are constructed sequentially on the support layer 165 may be located on the display 161. According to certain embodiments, a transparent cover is interposed between the display 161 and the FS. According to an embodiment, the support layer 165 may be omitted.

For example, a window cover 166 may be disposed on the FS. The window cover 166 may have a transparent property. The window cover 166 may serve to protect the FS. Meanwhile, sensitivity of the FS may be determined according to a thickness t1 of the window cover 166.

According to an embodiment, the display device 160 may include a touch panel, and the touch panel may include an FS in at least part of designated regions. For example, the FS is a capacitance-type sensor, and may also function as a touch sensor which detects a capacitance change caused by a specific shape of a touching fingerprint or detects a location of capacitance change in response to a touch to determine whether it is touched. A node at which the plurality of driving channels TX1 to TX5 and the plurality of detection channels RX1 to RX5 cross one another may function as a pixel for sensing a touch input or a fingerprint input. For example, if an image of a fingerprint is generated, that portion of the image of the fingerprint from the cross point of one of the driving channels TX1 to TX5 and one of the detection channels RX1 to RX5 can be one pixel. That is, self-capacitance or mutual-capacitance may change due to the touch input or the fingerprint input at the node at which the plurality of driving channels TX1 to TX5 and the plurality of detection channels RX1 to RX5 cross one another, and a coordinate of the touch input or an image of a touched fingerprint may be acquired from the capacitance change at the plurality of touched nodes.

According to an embodiment, the display device 160 may include the touch control circuit 167 for driving the touch panel including the FS. In some embodiments, it may be disposed separately from the FS. For example, the FS may be disposed on a Flexible Printed Circuit Board (FPCB) so as to be operatively coupled to a main processor (e.g., the main processor 121 of FIG. 1), or may be provided together with a control circuit for driving the display device 160. The touch control circuit 167 may include, for example, a driving electrode driver which outputs a driving signal and applies it to the driving electrode portion 130, a touch shift register for touch detecting coarse scan, a demultiplexer (DEMUX) for distributing an output of the touch shift register to the driving electrode driver, a shift register for fingerprint detecting fine scan.

Meanwhile, although it is illustrated in FIG. 3 that the touch control circuit 167 is coupled to an upper end of the driving electrode portion 162 and a left end of the detection electrode portion 163, the touch control circuit 167 may be equally coupled to a lower end of the driving electrode portion 162 and a right end of the detection electrode portion 163 (or lower end/left end, top end/right end).

According to an embodiment, when a driving signal is applied to the driving electrode portion 162, mutual capacitance may be generated between the driving electrode portion 162 and the detection electrode portion 163. When a finger F is in contact with the touch surface 166, there may be a change in mutual capacitance generated between the driving electrode portion 162 and electrodes adjacent to a region in contact with the finger F among a plurality of electrodes included in the detection electrode portion 163. The change in capacitance may be different in an electrode adjacent to a Finger Ridge (FR) of a fingerprint of the finger F and an electrode adjacent to a Finger Valley (FV) thereof. A gap of an electrode included in the detection electrode portion 163 may be set to be smaller than a gap of an FR and FV of a typical fingerprint, so that a fingerprint image can be calculated by detecting, for each position, a change in mutual capacitance caused by a finger adjacent to the detection electrode portion 163.

According to an embodiment, the driving electrode portion 162 may be disposed, based on a reference orientation of the device, in a horizontal direction (substantially horizontal, or within 5 degrees), and the detection electrode portion 163 may be disposed in a vertical direction (substantially vertical, or within 5 degrees).

In one embodiments, the fingerprint can be recognized by successively driving the driving channels TX1 and TX2, TX2 and TX3, TX3 and TX4, and TX4 and TX5 and subtracting the images from each.

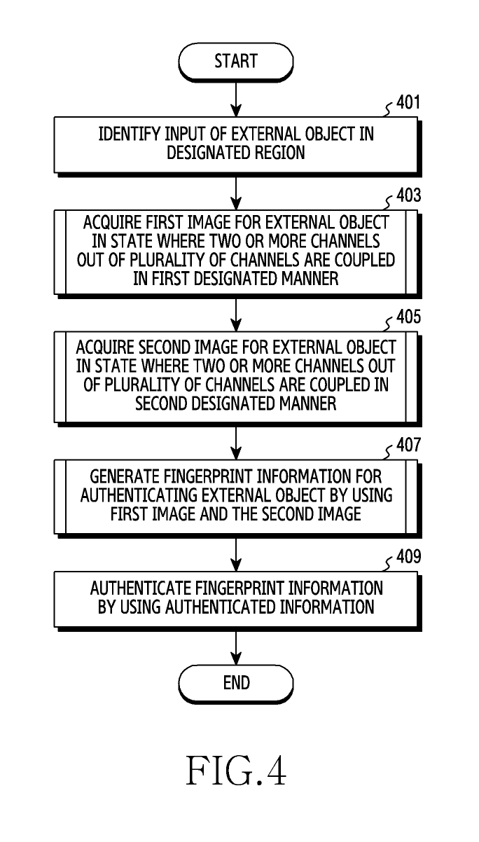

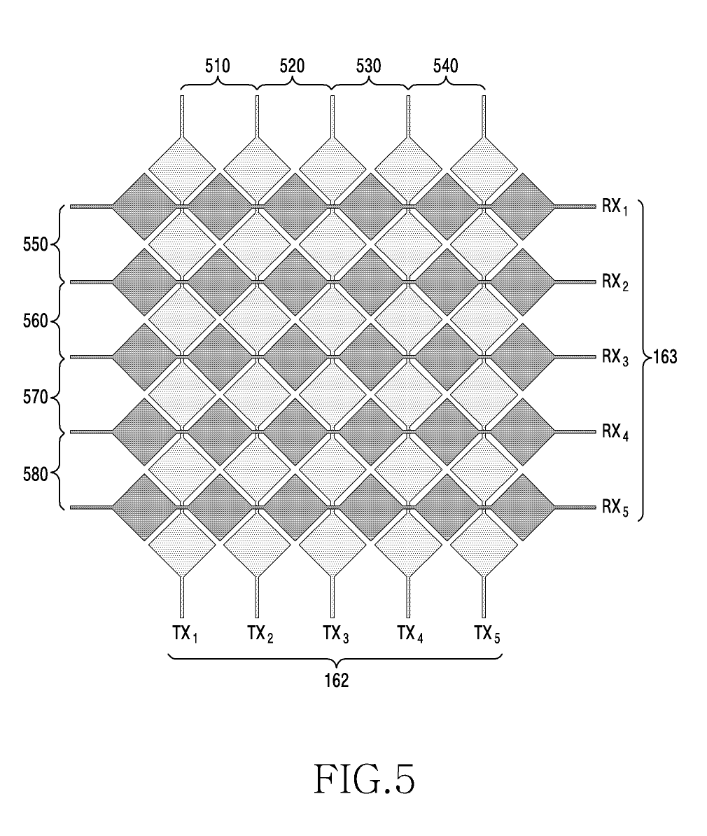

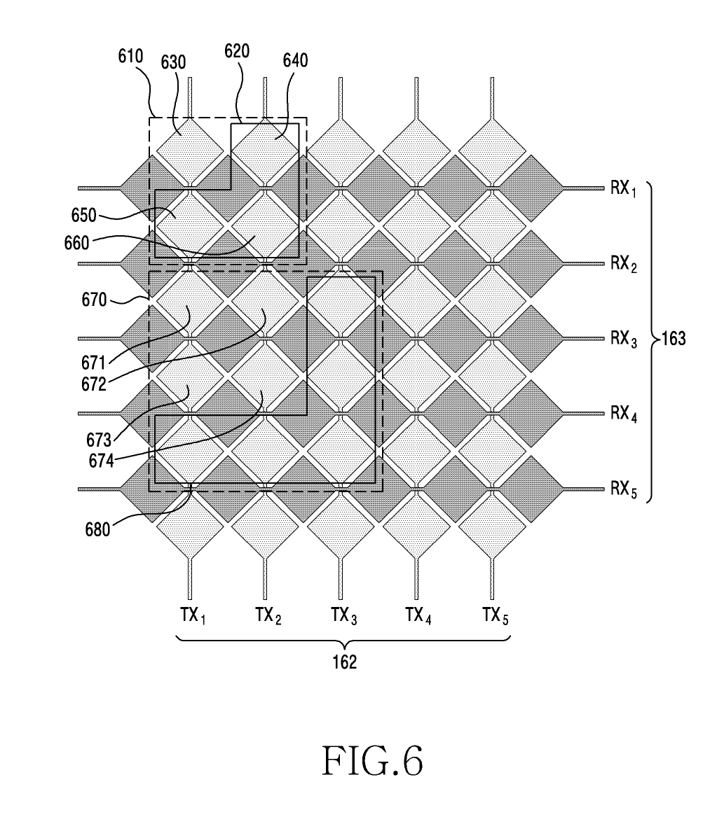

FIG. 4 is a flowchart for recognizing a fingerprint on the basis of a driving method for improving sensitivity of a fingerprint sensor in an electronic device according to certain embodiments. FIG. 5 illustrates an example in which a plurality of electrodes are coupled with a plurality of channels to improve sensitivity of a fingerprint sensor in an electronic device according to certain embodiments. FIG. 6 illustrates an example in which a plurality of electrodes are coupled on an area basis to improve sensitivity of a fingerprint sensor in an electronic device according to certain embodiments. In the following description, an electronic device (e.g., the electronic device 101), at least part (e.g., the processor 120, the display device 160) of the electronic device 101, or the touch control circuit 167 may be included. Meanwhile, at least part of an operation of the touch control circuit 167 described below may be performed by the processor 120.

Referring to FIG. 4 to FIG. 6, in operation 401, the electronic device 101 (e.g., the processor 120) may identify an input of an external object in a designated region by using the touch control circuit 167. For example, the touch control circuit 167 may identify an input of a user's finger in at least part of designated regions of a touch panel.

In operation 403, the electronic device 101 may acquire a first image for the external object in a state where two or more channels (for example, TX1 and TX2) out of a plurality of channels are coupled in a first designated manner 510 by using the touch control circuit 167 of FIG. 3, based at least on the input of the external object. For example, as shown in FIG. 5, the driving electrode portion 162 may include a plurality of driving channels TX1 to TX5 in which a plurality of driving electrodes are coupled in a vertical direction and a plurality of detection channels RX1 to RX5 in which a plurality of detection electrodes are coupled in a horizontal direction. For example, the touch control circuit 167 may acquire the first image for the external object in a state where the first driving channel TX1 and the second driving channel TX2 are coupled in the first designated manner 510. For example, the touch control circuit 167 may apply a driving signal to the first driving channel TX1 and the second driving channel TX2, and may receive a detection signal for the external object in the plurality of detection channels RX1 to RX5.

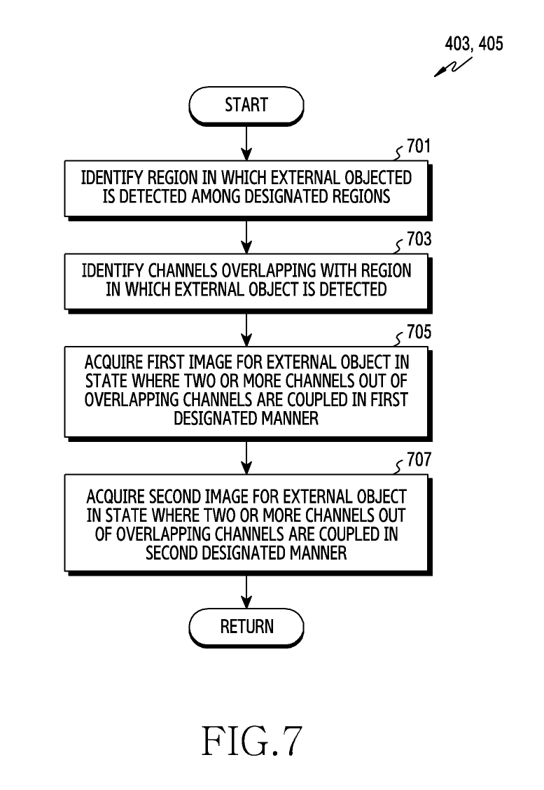

In operation 405, the electronic device 101 may acquire a second image for the external object in a state where two or more channels (for example, T2 and T3) out of a plurality of channels are coupled in a second designated manner 520 by using the touch control circuit 167, based at least on the input of the external object. For example, as shown in FIG. 5, the touch control circuit 167 may acquire the second image for the external object in a state where the second driving channel TX2 and the third driving channel TX3 are coupled in the second designated manner 520. For example, the touch control circuit 167 may apply a driving signal to the second driving channel TX2 and the third driving channel TX3, and may receive a detection signal for the external object in the plurality of detection channels RX1 to RX5. Operations 403 and 405 will be described in greater detail in FIG. 7.

According to an embodiment, two or more channels coupled in the second designated manner 520 may include (or share) at least one channel out of two or more channels coupled in the first designated manner 510. For example, as shown in FIG. 5, the second driving channel TX2 out of channels coupled in the first designated manner 510 may also be included in channels coupled in the second designated manner 520. That is, two or more channels coupled in different designated manners may equally include adjacent channels (e.g., the second driving channel TX2 of FIG. 5).

In operation 407, the electronic device 101 may generate fingerprint information for authenticating the external object by using the first image (from TX1 and TX2) and the second image (from TX2 and TX3). For example, the touch control circuit 167 may acquire difference data corresponding to at least one channel out of two or more channels coupled in the first designated manner 510 by subtracting the second image from the first image, and may generate the fingerprint information on the basis of the acquired difference data. For example, the touch control circuit 167 may subtract the second image acquired through the second driving channel TX2 and the third driving channel TX3 from the first image acquired through the first driving channel TX1 and the second driving channel TX2, may acquire difference data corresponding to the first driving channel TX1, and may generate the fingerprint information on the basis of the acquired difference data.

In operation 409, the electronic device 101 may authenticate the fingerprint information by using the authenticated fingerprint information. Herein, the authenticated fingerprint information may be pre-stored in the memory 130 as at least part of reference information for authenticating the fingerprint information generated in embodiments of the present disclosure. For example, the authenticated fingerprint information may include fingerprint information registered by the user by using a designated process (e.g., a registration process) or the like.

In an embodiment, the processor 120 may receive the fingerprint information from the touch control circuit 167, and may compare the received fingerprint information and the authenticated fingerprint information. If the fingerprint information coincides with the authenticated fingerprint information as a result of comparison, the processor 120 may identify whether a user who inputs the external object coincides with a user of the electronic device 101. For example, if the fingerprint information coincides with the authentication fingerprint information, the electronic device 101 may be configured to perform one or more operations associated with a designated security range. For example, if the fingerprint information is authenticated, the electronic device 101 may release a lock screen of the display unit 160, or may execute an application (e.g., a payment application) interworking with a security element or may execute a payment-related function. For example, the security element may include at least one of an embedded Security Element (eSE), a Subscriber Identification Module (SIM), an embedded Subscriber Identification Module (eSIM), and a device host. In certain embodiments of the present disclosure, when there is a need to perform one or more operations of the security range, the electronic device 101 may perform operations for acquiring the fingerprint information. Accordingly, when there is a need to perform one or more operations of the security range, the electronic device 101 may display a notification which causes the fingerprint information of the user on the display device 160.

According to an embodiment, the electronic device 101 may acquire an additional image, and may generate fingerprint information on the basis of the additional image. For example, the touch control circuit 167 may acquire a third image through the third driving channel TX3 and fourth driving channel TX4 coupled in a third designated manner 530, and may acquire a fourth image through the fourth driving channel TX4 and fifth driving channel TX5 coupled in a fourth designated manner 540. In addition, the touch control circuit 167 may subtract the third image from the second image, may acquire difference data corresponding to the second driving channel TX2, may subtract the fourth image from the third image, and may acquire difference data corresponding to the third driving channel TX3. Accordingly, the touch control circuit 167 may generate the fingerprint information on the basis of the difference data corresponding to the first driving channel TX1, the difference data corresponding to the second driving channel TX2, and the difference data corresponding to the third driving channel TX3. For example, the touch control circuit 167 may sequentially acquire the difference data corresponding to each of the driving channels TX1 to TX5 to acquire the fingerprint information.

According to an embodiment, the electronic device 101 may acquire images for the external object in a state where two or more detection channels out of the plurality of detection channels RX1 to RX5 are coupled in designated manners 550, 560, 570, and 580. For example, as shown in FIG. 5, the touch control circuit 167 may acquire the first image for the external object in a state where the first detection channel RX1 and the second detection channel RX2 are coupled in the fifth designated manner 550. Herein, the first mage may be an image corresponding to a plurality of driving electrodes (e.g., driving electrodes disposed to a first column and a second column) corresponding to the first detection channel RX1 and the second detection channel RX2. In addition, the touch control circuit 167 may acquire the second image for the external object in a state where the second detection channel RX2 and the third detection channel RX3 are coupled in a sixth designated manner 560. Herein, the second image may be an image corresponding to a plurality of driving electrodes (e.g., driving electrodes disposed on a second column and a third column) corresponding to the second detection channel RX2 and the third detection channel RX3. In addition, the touch control circuit 167 may subtract the second image from the first image, may acquire difference data corresponding to the first detection channel RX1, and may generate fingerprint information on the basis of the acquired difference data. In addition, unlike this, the touch control circuit 167 may acquire an additional image by sequentially using the plurality of detection channels RX3 to RX5, may acquire difference data corresponding to the second detection channel RX2, difference data corresponding to the third detection channel RX3, difference data corresponding to the fourth detection channel RX4, and difference data corresponding to the fifth detection channel RX5 on the basis of the additional image, and may generate fingerprint information on the basis of the plurality of pieces of difference data. Meanwhile, in case of using the plurality of detection channels RX1 to RX5 coupled in the designated manners 550, 560, 570, and 580, the touch control circuit 167 may apply a driving signal to at least part of the plurality of driving channels TX1 to TX5 or may apply the driving signal to all of them.

According to an embodiment, the electronic device 101 may acquire images for the external object in a state where two or more driving channels out of a plurality of driving channels 610 and 620 are coupled in a designated manner (e.g., on an area basis). For example, as shown in FIG. 6, the touch control circuit 167 may acquire the first image for the external object through the sixth driving channel 610 to which a first driving electrode 630, a second driving electrode 640, a third driving electrode 650, and a fourth driving electrode 660 are coupled on an area basis.

Herein, the first image may be an image corresponding to the first driving electrode 630 to the fourth driving electrode 660. In addition, the touch control circuit 167 may acquire the second image for the external object through the seventh driving channel 620 to which the second driving electrode 640, the third driving electrode 650, and the fourth driving electrode 660 are coupled on an area basis. Herein, the second image may be an image corresponding to the second driving electrode 630 to the fourth driving electrode 660.

In addition, the touch control circuit 167 may subtract the second image from the first image, may acquire difference data corresponding to the first driving electrode 630, and may generate fingerprint information on the basis of the acquired difference data. In addition, unlike this, the touch control circuit 167 may acquire an additional image since a plurality of driving channels are sequentially used on an area basis, may acquire difference data corresponding to each of the driving electrodes on the basis of the additional image, and may generate fingerprint information on the basis of the plurality of pieces of difference data. In addition, unlike this, the touch control circuit 167 may acquire difference data corresponding to a plurality of driving electrodes 671, 672, 673, and 674 by using difference data of an eighth driving channel 670 and ninth driving channel 680 in which the plurality of driving electrodes are coupled on an area basis, and may acquire an image on the basis of the acquired difference data. That is, the touch control circuit 167 may acquire difference data for at least one driving electrode by using a plurality of driving channels coupled in various manners. In addition, the touch control circuit 167 may acquire the difference data on an area basis by using a plurality of detection electrodes in the same manner as the plurality of driving electrodes.

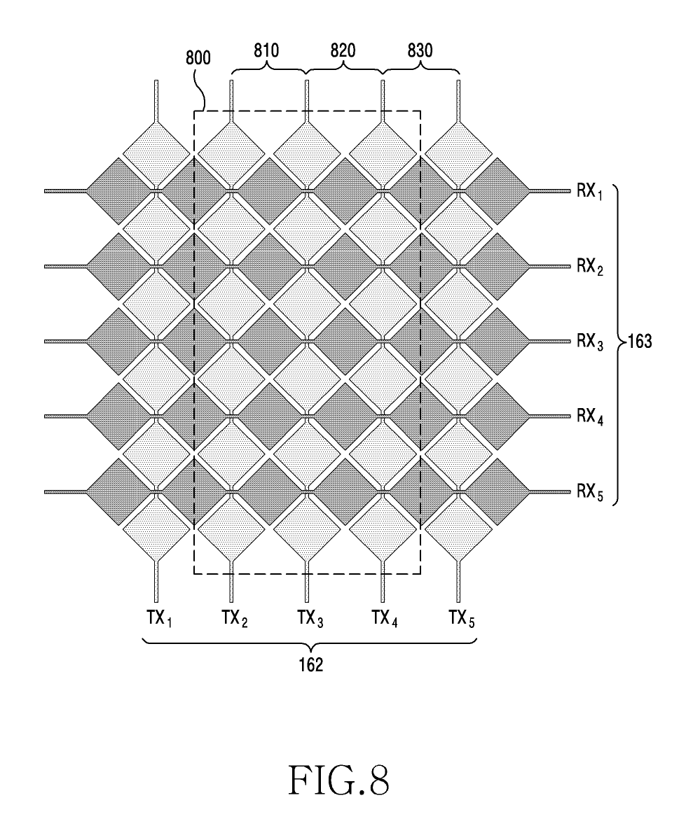

FIG. 7 is a flowchart for acquiring an image by using channels overlapping with a region in which an external object is detected in an electronic device according to certain embodiments. FIG. 8 illustrates an example for acquiring an image by using channels overlapping with a region in which an external object is detected in an electronic device according to certain embodiments. In the following description, the electronic device may include the electronic device 101 of FIG. 1, at least part (e.g., the processor 120, the display device 160) of the electronic device 101, and the touch control circuit 167 of FIG. 3. Meanwhile, an operation of the touch control circuit 167 may be performed in the processor 120.

The operation 403 and operation 405 of FIG. 4 will be described below in greater detail with reference to FIG. 7. In the description of the operation of the electronic device of FIG. 7, the same description as the operation of the electronic device of FIG. 4 will be omitted.

Referring to FIG. 7 and FIG. 8, in operation 701, the electronic device 101 may identify a region in which an external object (such as a fingertip) is detected among designated regions. For example, as shown in FIG. 8, the touch control circuit 167 may identify a region 800 in which a user's finger is detected.

In operation 703, the electronic device 101 may identify channels overlapping with the regions in which the external object is detected. For example, the touch control circuit 167 may identify a second driving channel TX2, a third driving channel TX3, and a fourth driving channel TX4 which overlap with the region 800 in which the external object is detected.

Accordingly, a first image from coupling driving channels TX2 and TX3 will be acquired and a second image from coupling driving channels TX3 and TX4 will be acquired.

In operation 705, the electronic device 101 may acquire a first image for the external object in a state where two or more channels out of the overlapping channels are coupled in a first designated manner. For example, the touch control circuit 167 may acquire the first image for the external object in a state where the second driving channel TX2 and third driving channel TX3 are coupled in a designated manner 810.

In operation 707, the electronic device 101 may acquire a second image for the external object in a state where two or more channels out of the overlapping channels are coupled in a second designated manner. For example, the touch control circuit 167 may acquire the second image for the external object in a state where the third driving channel TX3 and fourth driving channel TX4 are coupled in a designated manner 820.

After completing operation 707, the electronic device 101 may return to operation 407 and operation 409 of FIG. 4. For example, the touch control circuit 167 may acquire difference data corresponding to the second driving channel TX2 by subtracting the second image from the first image, and may generate fingerprint information on the basis of the acquired difference data. However, the foregoing is by way of example, and not limitation.

According to an embodiment, the electronic device 101 may acquire a third image for the external object in a state where the fourth driving channel TX4 and fifth driving channel TX5 are coupled in a designated manner 830, may acquire difference data corresponding to the third driving channel TX3 by subtracting the third image from the second image, may acquire difference data corresponding to the fourth driving channel TX4 in the same manner, and may generate fingerprint information on the basis of the acquired difference data.

The foregoing examples, show an overlap of one detecting channel. However, in certain embodiments, there can be overlap of more than one detecting channel.

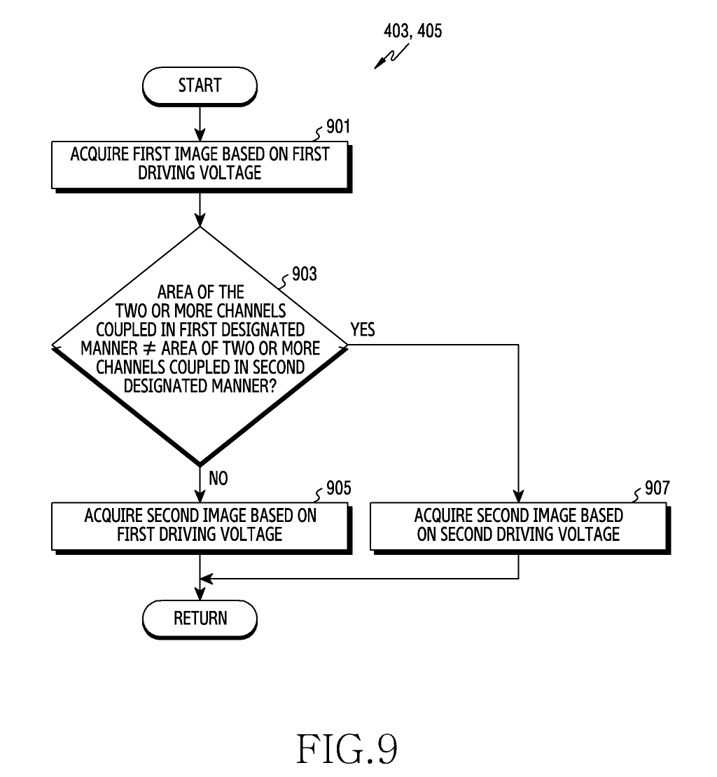

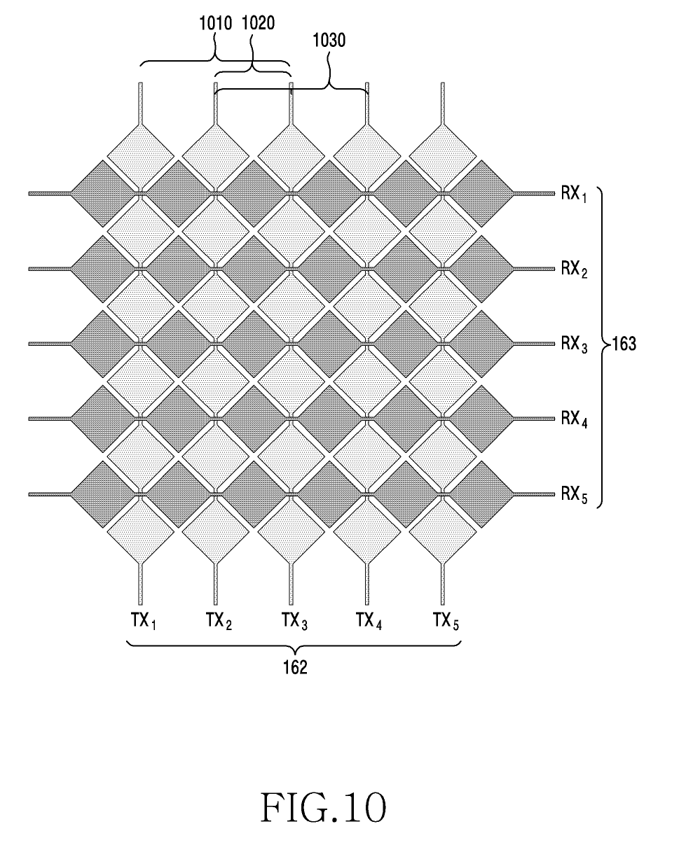

FIG. 9 is a flowchart for acquiring a first image and a second image on the basis of different driving voltage in an electronic device according to certain embodiments. FIG. 10 illustrates an example for acquiring a first image and a second image on the basis of different driving voltage in an electronic device according to certain embodiments. In the following description, the electronic device may include the electronic device 101 of FIG. 1, at least part (e.g., the processor 120, the display device 160) of the electronic device 101, and the touch control circuit 167 of FIG. 3. Meanwhile, an operation of the touch control circuit 167 may be performed in the processor 120.

The operation 403 and operation 405 of FIG. 4 will be described below in greater detail with reference to FIG. 9. In the description of the operation of the electronic device of FIG. 9, the same description as the operation of the electronic device of FIG. 4 will be omitted.

Referring to FIG. 9 and FIG. 10, in operation 901, the electronic device 101 may acquire a first image on the basis of first driving voltage. For example, the touch control circuit 167 may acquire the first image in a state where two or more channels out of a plurality of driving channels are coupled in a first designated manner 1010 on the basis of the first driving voltage. For example, the touch control circuit 167 may apply the first driving voltage to a first driving channel TX1, a second driving channel TX2, and a third driving channel TX3, and may acquire the first image for an external object in a state where the first driving channel TX1, the second driving channel TX2, and the third driving channel TX3 are coupled.

In operation 903, the electronic device 101 may identify whether an area of the two or more channels coupled in the first designated manner 1010 is different from an area of two or more channels coupled in a second designated manner 1020 or 1030. For example, the touch control circuit 167 may compare an area of driving channels coupled in the first designated manner 1010 and the area of driving channels coupled in the second designated manner 1020 or 1030.

As shown in FIG. 10, if the two or more channels coupled in the second designated manner 1030 are the second driving channel TX2, the third driving channel TX3, and the fourth driving channel TX4, the electronic device 101 may determine that an area of the plurality of driving channels TX1 to TX3 coupled in the first designated manner 1010 is equal to an area of the plurality of driving channels TX2 to TX4 coupled in the second designated manner 1030. Accordingly, proceeding to operation 905, the electronic device 101 may acquire a second image on the basis of first driving voltage. For example, the touch control circuit 167 may apply the first driving voltage to the second driving channel TX2, the third driving channel TX3, and the fourth driving channel TX4, and may acquire the second image for the external object in a state where the second driving channel TX2, the third driving channel TX3, and the fourth driving channel TX4 are coupled.

On the other hand, as shown in FIG. 10, if two or more channels coupled in the second designated manner 1020 are the second driving channel TX2 and the third driving channel TX3, the electronic device 101 may determine that the area of the plurality of driving channels TX1 to TX3 coupled in the first designated manner 1010 is different from the area of the plurality of driving channels TX2 and TX3 coupled in the second designated manner 1020. Accordingly, proceeding to operation 907, the electronic device 101 may acquire the second image on the basis of second driving voltage. For example, the touch control circuit 167 may apply the second driving voltage to the second driving channel TX2 and the third driving channel TX3, and may acquire the second image for the external object in a state where the second driving channel TX2 and the third driving channel TX3 are coupled.

Sensitivity of a Fingerprint Sensor (FS) may be in proportion to an area of a plurality of electrodes and a magnitude of driving voltage. If areas of channels respectively corresponding to the first image and the second image are different from one another, different driving voltage may be applied to channels coupled in the first designated manner and channels coupled in the second designated manners so that sensitivity of the channels are adjusted to the same level.

For example, if an area (e.g., a first area) of channels coupled in the first designated manner is greater than an area (e.g., a second area) of channels coupled in the second designated manner, the second image may be acquired by applying the second driving voltage greater than the first driving voltage to the channels coupled in the second designated manner. For another example, if the area of the channels coupled in the first designated manner is less than the area of the channels coupled in the second designated manner, the second image may be acquired by applying the second driving voltage less than the first driving voltage to the channels coupled in the second designated manner.

Accordingly, even if the areas of the channels coupled in the first designated manner and the second designated manner are different from one another, the first and second images with the same area may be acquired by changing a magnitude of each driving voltage. In the aforementioned embodiments, the comparing of the first area and the second area may include a case where the areas exactly coincide with each other as well as a case where the areas are identical or different from each other by at least a designated ratio. For example, if an area shared by the first area and the second area is identical by at least 90%, it may be determined that the both areas are identical. The ratio is not necessarily limited to 90%, and thus may be various such as 75%, 80%, 95%, etc.

After completing operation 905 or operation 907, the electronic device 101 may return to operation 407 and operation 409 of FIG. 4. The foregoing is by way of example, and not limitation.

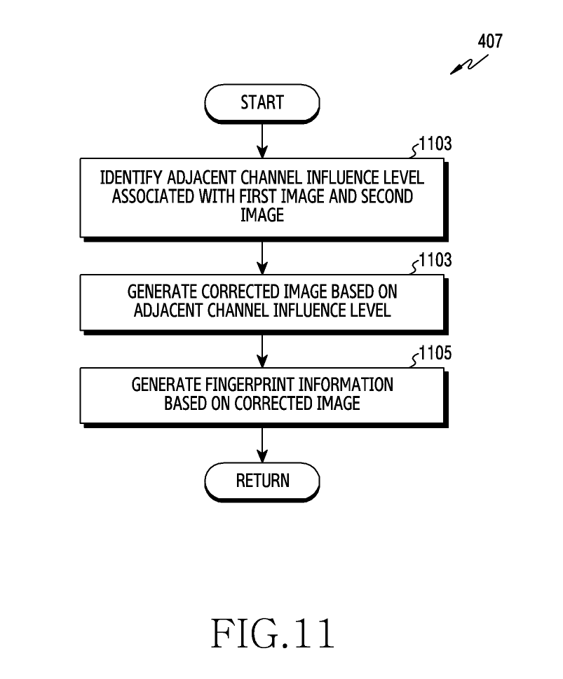

FIG. 11 is a flowchart for generating fingerprint information on the basis of an adjacent channel influence level in an electronic device according to certain embodiments. In the following description, the electronic device may include the electronic device 101 of FIG. 1, at least part (e.g., the processor 120, the display device 160) of the electronic device 101, and the touch control circuit 167 of FIG. 3. Meanwhile, an operation of the touch control circuit 167 may be performed in the processor 120.

The operation 407 of FIG. 4 will be described below in greater detail with reference to FIG. 11. In the description of the operation of the electronic device of FIG. 11, the same description as the operation of the electronic device of FIG. 4 will be omitted.

Referring to FIG. 11, in operation 1101, the electronic device 101 may identify an adjacent channel influence level associated with a first image and a second image. When an image is acquired by using one driving channel, the adjacent channel influence level may imply a level of influence acting on the acquire image due to data additionally acquired by the driving channel and adjacent channels.

For example, as shown in FIG. 5, third driving channel TX3, is an adjacent channel to TX1 and TX2 associated with the first image and may add noise to the first image. For another example, fourth driving channel TX4 is an adjacent channel to TX2 and TX3, associated with the second image and may add noise to the second image. The electronic device 101 may identify an adjacent channel influence level/noise of the third driving channel TX3 for the first image. In addition, the electronic device 101 may identify an adjacent channel influence level/noise of the first driving channel TX1 and fourth driving channel TX4 for the second image. In an embodiment, the adjacent channel influence level may be pre-stored in the memory 130 of FIG. 1. In another embodiment, the electronic device 101 may evaluate an influence level of an adjacent channel in advance by considering a result obtained by driving a Fingerprint Sensor (FS), and may store the adjacent channel influence level/noise obtained by considering the evaluation result in the memory 130.

In operation 1103, the electronic device 101 may generate at least one corrected image out of the first image and the second image on the basis of the identified adjacent channel influence/noise level. For example, the touch control circuit 167 may correct the first image corresponding to the first driving channel TX1 and the second driving channel TX2 on the basis of an influence level of the adjacent third driving channel TX3. In addition, the touch control circuit 167 may correct the second image corresponding to the second driving channel TX2 and the third driving channel TX3 on the basis of an influence level of the adjacent first driving channel TX1 and fourth driving channel TX4.

In operation 1105, the electronic device 101 may generate fingerprint information on the basis of the corrected image. For example, the touch control circuit 167 may subtract a corrected image corresponding to the second driving channel TX2 and the third driving channel TX2 from a corrected image corresponding to the first driving channel TX1 and the second driving channel TX2, may acquire difference data corresponding to the first driving channel TX1, and may generate the fingerprint information.

After completing operation 1107, the electronic device 101 may return to operation 409 of FIG. 4. However, this is not for limitation purposes.

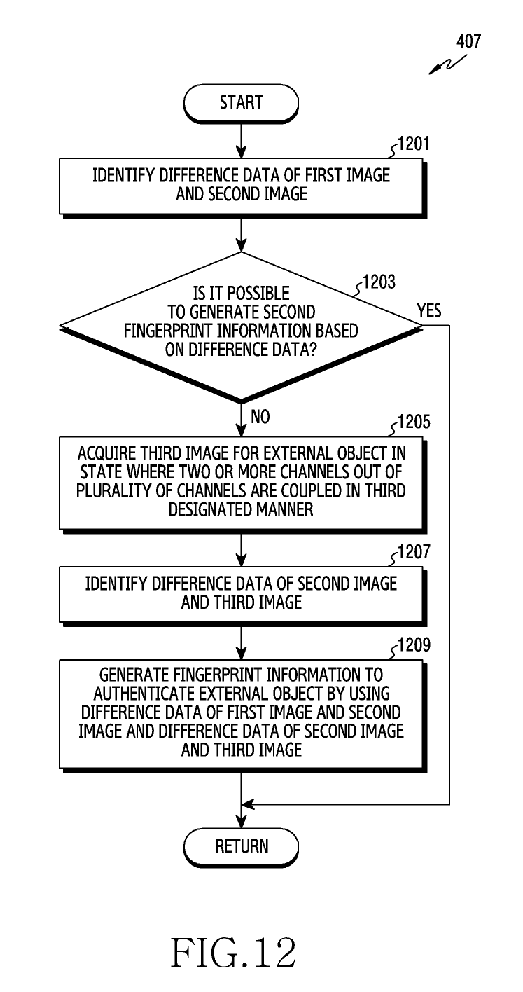

FIG. 12 is a flowchart for additionally acquiring a third image to generate fingerprint information in an electronic device according to certain embodiments. In the following description, the electronic device may include the electronic device 101 of FIG. 1, at least part (e.g., the processor 120, the display device 160) of the electronic device 101, and the touch control circuit 167 of FIG. 3. Meanwhile, an operation of the touch control circuit 167 may be performed in the processor 120.

The operation 407 of FIG. 4 will be described below in greater detail with reference to FIG. 12. In the description of the operation of the electronic device of FIG. 12, the same description as the operation of the electronic device of FIG. 4 will be omitted.

Referring to FIG. 12, in operation 1201, the electronic device 101 may identify difference data of a first image and a second image. For example, as shown in FIG. 5, the touch control circuit 167 may identify difference data corresponding to a first driving channel TX1 by subtracting the second image from the first image.

In operation 1203, the electronic device 101 may determine whether it is possible to generate fingerprint information on the basis of the difference data. For example, the touch control circuit 167 may determine whether it is possible to generate data (e.g., fingerprint data) for an external object on the basis of the identified difference data.

If it is possible to generate the fingerprint information on the basis of the difference data, the electronic device 101 may return to operation 409 of FIG. 4.

Otherwise, if it is not possible to generate the fingerprint on the basis of the difference data, proceeding to operation 1205, the electronic device 101 may acquire a third image for the external object in a state where two or more channels out of the plurality of channels are coupled in a third designated manner. For example, as shown in FIG. 5, the touch control circuit 167 may acquire the third image by using the third detection channel TX3 and the fourth driving channel TX4 which are coupled in the third designated manner 530.

In operation 1207, the electronic device 101 may identify difference data of the second image and the third image. For example, as shown in FIG. 5, the touch control circuit 167 may identify difference data corresponding to the second driving channel TX2 by subtracting the third image from the second image.

In operation 1209, the electronic device 101 may generate fingerprint information to authenticate the external object by using difference data of the first image and the second image and difference data of the second image and the third image. For example, the touch control circuit 167 may generate the fingerprint information on the basis of difference data corresponding to the first driving channel TX1 and difference data corresponding to the second driving channel TX2.

After completing operation 1209, the electronic device 101 may return to operation 409 of FIG. 4. The foregoing is by way of example and not limitation.

According to an embodiment, unlike in FIG. 12, the electronic device 101 may perform operation 1203 whenever difference data corresponding to each channel is acquired. For example, the electronic device 101 may determine whether it is possible to generate fingerprint information on the basis of the difference data corresponding to the first driving channel TX1 and difference data corresponding to the second driving channel TX2 if the difference data corresponding to the second driving channel TX2 is acquired, and may perform operations for acquiring difference data corresponding to the third driving channel TX3 if it is not possible to generate the fingerprint information. That is, the electronic device 101 may repeatedly perform an operation of acquiring difference data corresponding to each channel to generate the fingerprint information.

According to certain embodiments, there is method executed in an electronic device with a touch panel comprising a plurality of electrodes and a plurality of channel electrically coupled in a designated direction with the plurality of electrodes in at least part of designated regions and a touch control circuit for driving the touch panel, the method comprising: identifying an input of an external object in the designated regions; acquiring a first image for the external object with two or more channels out of the plurality of channels, based at least on the input; acquiring a second image for the external object with another two or more channels out of the plurality of channels, based at least on the input; and authenticating the external object with the first image and the second image, thereby generating fingerprint information.

According to certain embodiments, the method may further include authenticating the fingerprint information by using exemplar fingerprint information stored in a memory of the electronic device.

According to certain embodiments, the method may further include performing one or more operations associated with a designated security range when the external object is authenticated.

According to certain embodiments, the method may further include acquiring difference data corresponding to at least one channel common to the two or more channels and the another two or more channels by subtracting the second image from the first image, and generating the fingerprint information, based at least on the acquired difference data.

According to certain embodiments, wherein the two or more channels, and the another two or more channels comprise at least one common channel.

According to certain embodiments, the method may further include identifying a region in which the external object is detected among the designated regions; identifying channels overlapping with the region in which the external object is detected; acquiring the first image for the external object in a state where the another two or more channels are among the overlapping channels; and acquiring the second image for the external object in a state where the another two or more channels among the overlapping channels.

According to certain embodiments, the method may further include acquiring the first image by applying first driving voltage to the two or more channels; comparing a first area of the two or more channels and a second area of the another two or more channels; and acquiring the second image by applying second driving voltage to the another two or more channels when the first area and the second area are different by at least a designated rate.

According to certain embodiments, the method may further include acquiring the second image by applying the first driving voltage to the another two or more channels when the first area and the second area are identical by at least the designated ratio.

According to certain embodiments, the method may further include identifying an adjacent channel influence level associated with the plurality of channels; generating at least one corrected image out of the first image and the second image on the basis of the adjacent channel influence level; and generating the fingerprint information on the basis of the corrected image.

According to certain embodiments, the method may further include identifying difference data of the first image and the second image, determining whether it is possible to generate the fingerprint information on the basis of the difference data, acquiring a third image for the external object in a state where two or more channels out of the plurality of channels are coupled in a third designated manner on the basis of the input, if it is not possible to generate the fingerprint information, and generating the fingerprint information for authenticating the external object by using the first image, the second image, and the third image.

Certain aspects of the above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

Meanwhile, the exemplary embodiments disclosed in the specification and drawings are merely presented to easily describe the technical contents of the present disclosure and help with the understanding of the present disclosure and are not intended to limit the scope of the present disclosure. Therefore, all changes or modifications derived from the technical idea of the present disclosure as well as the embodiments described herein should be interpreted to belong to the scope of the present disclosure.

What is claimed is:

1. An electronic device comprising:
a touch panel comprising a plurality of electrodes and a plurality of channel electrically coupled in a designated direction with the plurality of electrodes in at least part of designated regions;
a touch control circuit for driving the touch panel; and
a processor, wherein the processor is configured to:
identify an input of an external object in the designated regions;
acquire a first image for the external object in a state where two or more channels out of the plurality of channels are coupled by the touch control circuit, based at least on the input;
acquire a second image for the external object in a state where another two or more channels out of the plurality of channels are coupled by the touch control circuit, based at least on the input; and
authenticating the external object with the first image and the second image, thereby generating fingerprint information.

2. The electronic device of claim 1, further comprising a memory for storing exemplar fingerprint information, wherein the processor is configured to authenticate the fingerprint information using the exemplar fingerprint information.

3. The electronic device of claim 2, further comprising a display device, wherein the processor is configured to perform one or more operations associated with a designated security range when the external object is authenticated.

4. The electronic device of claim 1, wherein the processor is configured to:
acquire difference data corresponding to at least one channel common to the two or more channels and the another two or more channels by subtracting the second image from the first image; and
generate the fingerprint information, based at least on the acquired difference data.

5. The electronic device of claim 1, wherein the two or more channels, and the another two or more channels comprise at least one common channel.

6. The electronic device of claim 1, wherein the processor is configured to:
identify a region in which the external object is detected among the designated regions by using the touch control circuit;
identify channels overlapping with the region in which the external object is detected by using the touch control circuit;
acquire the first image for the external object in a state where the two or more channels are among the overlapping channels using the touch control circuit; and
acquire the second image for the external object in a state where the another two or more channels are among the overlapping channels using the touch control circuit.

7. The electronic device of claim 1, wherein the processor is configured to:
acquire the first image by applying first driving voltage to the two or more channels using the touch control circuit;
compare a first area of the two or more channels and a second area of the another two or more channels; and
acquire the second image by applying second driving voltage to the another two or more channels using the touch control circuit if the first area and the second area are different by at least a designated rate.

8. The electronic device of claim 7, wherein the processor is configured to acquire the second image by applying the first driving voltage to the another two or more channels using the touch control circuit if the first area and the second area are identical by at least the designated rate.

9. The electronic device of claim 1, wherein the processor is configured to:
identify an adjacent channel influence level associated with the plurality of channels;
generate at least one corrected image out of the first image and the second image on the basis of the adjacent channel influence level; and
generate the fingerprint information on the basis of the corrected image.

10. The electronic device of claim 1, wherein the processor is configured to:
identify difference data of the first image and the second image;
determine whether it is possible to generate the fingerprint information on the basis of the difference data;
acquire a third image for the external object with a third two or more channels out of the plurality of channels using the touch control circuit on the basis of the input, if it is not possible to generate the fingerprint information; and
generate the fingerprint information for authenticating the external object by using the first image, the second image, and the third image.

11. A method executed in an electronic device with a touch panel comprising a plurality of electrodes and a plurality of channel electrically coupled in a designated direction with the plurality of electrodes in at least part of designated regions and a touch control circuit for driving the touch panel, the method comprising:
identifying an input of an external object in the designated regions;
acquiring a first image for the external object with two or more channels out of the plurality of channels, based at least on the input;
acquiring a second image for the external object with another two or more channels out of the plurality of channels, based at least on the input; and
authenticating the external object with the first image and the second image, thereby generating fingerprint information.

12. The method of claim 11, further comprising authenticating the fingerprint information by using exemplar fingerprint information stored in a memory of the electronic device.

13. The method of claim 12, further comprising performing one or more operations associated with a designated security range when the external object is authenticated.

14. The method of claim 11, further comprising:
acquiring difference data corresponding to at least one channel common to the two or more channels and the another two or more channels by subtracting the second image from the first image; and
generating the fingerprint information, based at least on the acquired difference data.

15. The method of claim 11, wherein the two or more channels, and the another two or more channels comprise at least one common channel.

16. The method of claim 11, further comprising:
identifying a region in which the external object is detected among the designated regions;
identifying channels overlapping with the region in which the external object is detected;
acquiring the first image for the external object in a state where the another two or more channels are among the overlapping channels; and
acquiring the second image for the external object in a state where the another two or more channels among the overlapping channels.

17. The method of claim 11, further comprising:
acquiring the first image by applying first driving voltage to the two or more channels;
comparing a first area of the two or more channels and a second area of the another two or more channels; and
acquiring the second image by applying second driving voltage to the another two or more channels when the first area and the second area are different by at least a designated rate.

18. The method of claim 17, further comprising acquiring the second image by applying the first driving voltage to the another two or more channels when the first area and the second area are identical by at least the designated rate.

19. The method of claim 11, further comprising:
identifying an adjacent channel influence level associated with the plurality of channels;
generating at least one corrected image out of the first image and the second image on the basis of the adjacent channel influence level; and
generating the fingerprint information on the basis of the corrected image.

20. An electronic device comprising:
a sensor that can be driven in one of a first designated manner and a second designated manner; and
a processor, wherein the processor is configured to:
identify an input of an external object in designated regions;
acquire a first image for the external object by using the sensor, based at least on the input;
acquire a second image for the external object in a second designated manner by using the sensor, based at least on the input; and
generate fingerprint information for authenticating the external object by using the first image and the second image.
